(19) United States
(12) Patent Application Publication
(10) Pub. No.: US 2007/0207694 A1
(43) Pub. Date: Sep. 6, 2007

(54) MANUFACTURING PROCESS OF SUBSTRATE FOR IMAGE DISPLAY PANEL

(76) Inventors: Akira Yoda, Kanagawa (JP); Hiroshi Kikuchi, Kanagawa (JP)

Correspondence Address: 3M INNOVATIVE PROPERTIES COMPANY, PO BOX 33427, ST. PAUL, MN, 55133-3427, US

(21) Appl. No.: 10/595,773

(22) PCT Filed: Oct. 6, 2004
(86) PCT No.: PCT/US04/32801

§ 371 Date: Mar. 15, 2007

(30) Foreign Application Priority Data
Nov. 12, 2003 (JP) 2003-382775

(51) Int. Cl. H01J 9/24

(52) U.S. Cl. 445/24

(57) ABSTRACT

A manufacturing process of a substrate for an image display panel comprising a transparent substrate and protruding ribs and thin film electrodes each formed on the surface of the substrate in the predetermined pattern, in which the process comprises the steps of forming an electrode precursor layer by coating an electrode precursor on the surface of the substrate in the predetermined patter, forming a rib layer in the predetermined pattern on the surface of the substrate on which the electrode precursor layer has been formed, and sintering the electrode precursor layer and the rib precursor layer simultaneously at the predetermined temperature.

### BACKGROUND

A panel-shaped image display apparatus includes a liquid crystal (LC) display panel, an organic electroluminescence (EL) display panel, a plasma display panel (“PDP”), and so forth. Particularly, a PDP is characterized by being thin and capable of providing a large display, for industrial purposes and recently for use as a wall-hung TV. Generally, a PDP has a number of small discharge display cells as shown schematically in FIG. 1. In a PDP 50, each discharge display cell 53 is surrounded and defined by a pair of glass substrates separated from and opposed to each other, that is, a front glass substrate 61 and a back glass substrate 51, and ribs (also referred to as barrier ribs, partition walls or barrier walls) 54 having a fine structure arranged in a predetermined pattern between these glass substrates. The front glass substrate 61 comprises a transparent display electrode 63 consisting of scan electrodes and sustain electrodes, a transparent dielectric layer 62 and a transparent protective layer 64 thereon. The back glass substrate 51 comprises an address electrode 53 and a dielectric layer 52 thereon. Each discharge display cell 56 has a phosphor layer 55 on the inner wall and at the same time a rare gas (for example, Ne—Xe gas) is enclosed for a self light-emitting display by a plasma discharge between the above-mentioned electrodes.

In general, the rib 54 has a ceramic fine structure and is normally provided on the back glass substrate 51 together with the address electrode 53, making up a back plate for a PDP, as shown schematically in FIG. 2. As the shape and the dimensional precision of the rib 54 considerably affect the performance of a PDP, it is formed in various patterns. A typical one is a stripe rib pattern 54 shown in FIG. 2, and in this case, each discharge display cell 56 also has a stripe pattern.

Particularly, in the substrate for a PDP as described above, an electrode is generally formed from a conductive electrode material such as silver by use of the photolithographic method or the screen-printing method. For example, the formation of a silver electrode by use of the photolithographic method is carried out by performing a series of processes of exposing with a photo-mask, developing and drying after coating a photosensitive silver paste on the entire surface of a glass substrate, and by curing the silver paste by sintering. On the other hand, the formation of a silver electrode by use of the screen printing method, which is a more simplified method, is carried out by drying in a drying oven after screen-printing a silver paste designed for printing in a fixed pattern directly on a glass substrate, and by curing the silver paste by sintering.

Ribs for a PDP substrate are generally formed by use of a screen printing method, a sand blast method, a transfer method, and so forth, after forming electrodes on a glass substrate as described above. For example, the formation of ribs by use of the transfer method is carried out by performing the processes of: filling the recess in a mold sheet having a printing mask in accordance with the shape of the rib with a ceramic paste; contacting the mold sheet closely to the glass substrate; peeling off the mold sheet and transferring the ceramic paste from the sheet recess onto the glass substrate; curing the ceramic paste by sintering.

However, when manufacturing a PDP substrate equipped with ribs and electrodes by use of the above-mentioned methods, at least three heating processes, that is, a drying process and a sintering process during an electrode formation stage and a sintering process during a rib formation stage, are utilized that consume substantial amounts of energy and a large amount of equipment investment. It has been suggested in the prior art to form ribs and electrodes simultaneously or reduce the number of heating steps.

For example, a method for manufacturing a PDP substrate has been proposed, that is characterized in that after a rib forming mold is bonded and fixed to an insulating substrate with an electrode composition, the recess in the rib forming mold is filled with a rib material and solidified, and then is sintered integrally with the insulating substrate at a temperature of 500 to 650° C. for forming ribs and electrodes simultaneously (JP 10-241581).

On the other hand, a method for manufacturing a back plate for a PDP has been proposed, that is characterized in that at least one of a rib forming part consisting of a rib precursor mixture and an electrode pattern including an electrode material, and a multicolor pattern including a phosphor are baked in a state in which they are formed on a substrate in a prescribed arrangement (JP 10-334793).

Moreover, a method for manufacturing a substrate for a PDP has been proposed, that is characterized in that after electrode patterns are formed on a glass substrate by use of a paste for the electrodes, and a dielectric material paste applied layer is formed by applying a dielectric material paste thereon, and further a rib pattern is formed by use of a paste for rib thereon, the rib pattern is baked together with the electrode patterns and the dielectric material paste applied layer (JP 11-329236).

Another method for manufacturing a PDP has been proposed, that is characterized by comprising a first process in which a thick film pattern material of an electrode is formed by use of a first type roller, and a second process in which a thick film pattern material of a rib is formed by use of a second type roller (JP 001-35363)

### SUMMARY OF THE INVENTION

The methods just describe employ at least two heating processes. Also these methods utilize relatively large equipment having a complex structure.

Described herein is a manufacturing process of a substrate for an image display panel comprising a transparent substrate and protruding ribs and thin film electrodes each formed in the predetermined pattern on the surface of the substrate, characterized by comprising steps of: forming an electrode precursor layer by coating an electrode precursor on the surface of the substrate in the predetermined pattern; forming a rib precursor layer in the predetermined pattern on the surface of the substrate on which the electrode precursor layer has been formed; and sintering the electrode precursor layer and the rib precursor layer simultaneously at a predetermined temperature.

The method reduces the number of process steps by reducing the number of heating step to one-step, thereby reducing energy consumption and equipment investment, when manufacturing a PDP substrate equipped with ribs and electrodes or other substrates for use in an image display panel.

Further, it is possible to manufacture ribs highly precisely without the occurrence of bubbles and defects such as pattern deformation, particularly by use of the transfer method for forming ribs.

Furthermore, it is possible to manufacture ribs having a complex structure with high dimensional precision without requiring skill and easily carry out peeling from the forming mold without damages to the ribs.

### BRIEF DESCRIPTION OF THE DRAWINGS

FIG. 1 is a sectional view of an illustrative PDP.

FIG. 2 is a perspective view of a back plate for a PDP used in the PDP in FIG. 1.

FIG. 3 shows sectional views illustrating a manufacturing process of a substrate for a PDP of the present invention.

FIG. 4 shows sectional views illustrating the barrier rib forming process in the manufacturing process of a substrate for a PDP in FIG. 3.

### DETAILED DESCRIPTION OF PREFERRED EMBODIMENTS

The manufacturing process of a substrate for an image display panel according to the present invention is particularly suitable to manufacture a substrate comprising a transparent substrate and protruding ribs and thin film electrodes formed in a predetermined pattern, respectively, on the surface of the substrate. A substrate having such a structure includes a substrate for an image display panel such as an LC display panel, an EL display panel, a PDP, and the like.

The practice of the present invention will be described in detail below by referring to a manufacturing process of a substrate for a PDP. The present invention is not limited to the manufacture of a PDP substrate. In the following description, “substrate equipped with ribs and electrodes” is also referred to as “panel substrate” in order to distinguish it from a transparent substrate.

As already described referring to FIG. 2, the rib 54 of the PDP 50 is provided on the back glass substrate 51, making up a back plate for a PDP (substrate for a PDP). Although the interval between the ribs 54 (cell pitch) varies depending on the screen size or the like, a range of approximately 150 to 400 μm is typical. In general, it is necessary for the ribs to “be free from a mixture of bubbles and defects such as deformation” and “be excellent in pitch precision.” As for the pitch precision, it is necessary to provide the rib to a predetermined position with almost no displacement with respect to the address electrode 53 on the back glass substrate 51 in the course of formation of ribs, and in fact allowable positional errors need to be within tens of μm. If the positional error exceeds tens of μm, the conditions for emitting visible light and the like are adversely affected particularly for larger screens.

When the ribs 54 are viewed as a whole, although there are some differences depending on the size of a substrate for a PDP and the shape of the rib, the total pitch (distance between the ribs 54 on both ends; only five ribs are shown schematically but actually there are approximately 3,000 ribs) of the ribs 54 needs to be less than tens of ppm in dimensional precision generally. Moreover, in the practice of the present invention, it is effective to form ribs by use of a flexible forming mold consisting of a supporting body and a shaping layer with a groove pattern supported by the supporting body, and in the case of such a forming method, the total pitch (distance between the grooves on both ends) of the forming mold needs to be less than tens of ppm in dimensional precision, as in the ribs.

The panel substrate according to the present invention has a substrate (also called ”base material” or “base”) that supports ribs and electrodes. Preferably, it is necessary for the substrate used herein to have a transparency high enough to transmit light to carry out a curing process, in which ribs and electrodes are cured by the irradiation of light (in this specification, as is generally recognized in the field of photolithography, light from various light sources such as visible light, ultraviolet rays, and infrared rays, and laser beams and electron beams is generally called “light”). It is preferable, therefore, that the substrate is substantially transparent. For example, a transparent substrate material includes, but is not limited to, glass (for example, soda glass, borosilicate glass, and so forth), ceramics, plastic, and so forth. The dimensions of these substrates can be changed in a considerably wide range according to, for example, the size of the desired panel substrate. For example, the thickness of a substrate has normally a range of approximately 0.5 to 10 mm.

On the surface of a transparent substrate, protruding ribs and thin film electrodes are at least provided. The protruding ribs are not particularly restricted in shape, size and array pattern, but in general, they have a straight rib pattern in which plural ribs are arranged in parallel to each another, as described above referring to FIG. 2. The ribs can also have a grid-shaped (matrix) rib pattern in which a first set of ribs are arranged (at a certain intervals) substantially in parallel and a second set of parallel ribs intersect the first set of ribs (such as wherein the second set of ribs intersect the first set of ribs in a substantially orthogonal direction, or a delta (meander)-shaped rib pattern. In the case of the grid-shaped rib pattern or the delta-shaped rib pattern, it is possible to improve the display performance because a state is established in which each discharge display cell is separated by the rib pattern as a small area. Although these ribs can be formed by use of various materials and methods, they can be advantageously formed from a rib precursor comprising a photo-curable material, as described in detail below.

In the panel substrate according to the present invention, thin film electrodes combined with ribs are formed at an arbitrary position on the transparent substrate. The electrodes, as in the ribs, are not restricted in shape, size and array pattern. In the case of a substrate for a PDP, for example, it is possible to form the electrode, so-called here, as an address electrode on the bottom of a discharge display cell formed by neighboring ribs, as described above referring to FIG. 2. The address electrodes are normally formed in such a way that pairs of address electrodes are independently provided on the surface of a transparent substrate at certain intervals in substantially parallel to each another. Although the electrodes can be formed by use of various materials and methods, they can be advantageously formed from an electrode precursor comprising a photo-curable material, as described in detail below.

The manufacturing process of a panel substrate according to the present invention is characterized by carrying out in order the following steps of:

(1) forming an electrode precursor layer by coating an electrode precursor in a predetermined pattern on the surface of a transparent substrate;

(2) forming a rib precursor layer in a predetermined pattern on the surface of the substrate on which the electrode precursor layer has been formed; and

(3) sintering the electrode precursor layer and the rib precursor layer simultaneously at a predetermined temperature, after sequential formation of the above layers according to the above-mentioned steps.

If necessary, the order of these steps may be changed and when a dielectric layer or other layers are necessary on the panel substrate, it is possible to additionally provide a step of forming such a layer.

The manufacturing process of the present invention is also characterized in that after an electrode precursor layer is formed, a step of forming a rib precursor layer is carried out immediately, without forming an electrode layer by sintering the electrode precursor layer. In other words, according to the manufacturing process of the present invention, after an electrode precursor layer is formed, it is possible to carry out the subsequent step of forming a barrier precursor layer, without putting the electrode precursor layer into the drying step, and in this case no problem is caused by omitting the drying step based on heating. The omission of the drying step can make a considerable contribution toward reducing the energy consumption.

In the practice of the present invention, the electrode precursor layer for finally forming an electrode can be formed by use of various film forming methods. A proper film forming method includes, for example, the screen printing method, printing methods other than the screen printing method, the photolithographic method, and so forth. The most preferable method is the screen printing method. When other film forming methods are used, caution must be taken because there is the possibility that when the rib precursor is laminated together with the forming mold in a state in which the precursor layer is not dried well yet, the rib precursor and the electrode precursor are mixed and the electrode pattern may be damaged. Moreover, there is another possibility that if the electrode precursor and the cured rib precursor are not sufficiently bonded to each other, and when the panel substrate is removed from the forming mold, the rib precursor is not transferred to the substrate side together with the electrode precursor but remains in the forming mold therefore the rib pattern may not be formed successively, and in this case caution must be taken also.

Normally, a paste-like electrode precursor suitable for thin film formation is used to form an electrode precursor layer. Preferably, an electrode precursor paste is composed of a photo-curable material but if necessary, it can be composed of heat-curable material or a material that can be cured under other conditions. Preferably, an electrode precursor paste is a silver paste, silver-palladium paste, gold paste, nickel paste, copper paste, aluminum paste, and so forth, and it is possible for each paste to have a composition that is generally adopted in a process of forming electrodes or other conductive films. For example, a silver paste is one in which silver powder, glass powder or frit, and other essential ingredients are scattered uniformly in a photo-curable resin. These electrode precursor pastes are coated on the surface of a transparent substrate by use of methods such as the screen printing method described above, but it is necessary that the coating pattern corresponds to the desired electrode pattern and the pattern width and the film thickness are determined with the loss due to contraction during sintering being taken into consideration. The film thickness of the coated paste can be changed in a wide range according to the thickness of the desired electrode, but normally it is preferable for the thickness of the electrode obtained after sintering to be within a range of approximately 3 to 50 μm, more preferably, within a range of approximately 4 to 25 μm, and most preferably, within a range of approximately 5 to 10 μm.

For example, the process of forming an electrode precursor by use of the screen printing method can be advantageously carried out as follows.

First, an electrode precursor paste selected for forming electrodes is printed by use of the screen printing method in a predetermined pattern and with a predetermined film thickness on a transparent substrate such as a glass substrate. The paste used here is photo-curable. Then, the obtained printed material of the paste is irradiated with light that can initiate the curing of the paste. The type of light used to cure the paste and its irradiation intensity depend on the paste composition, but typical light for curing is visible light or ultraviolet rays because of the easiness in handling, and so forth. It is preferable to cure the paste by the irradiation with light under an inert gas atmosphere. A proper inert gas includes a nitrogen gas, an argon gas, and so forth. From the standpoint of cost and handling, and so forth, a nitrogen gas is the most preferable. By the irradiation with light, the curing reaction of the paste is initiated and an electrode precursor layer having a predetermined pattern that corresponds to that of the intended electrodes can be obtained.

After the electrode precursor layer is formed as described above, the subsequent process of forming a rib precursor is carried out without drying the layer.

A rib precursor layer is formed preferably by use of the transfer method. In other words, a rib precursor layer is formed in advance on a proper supporting body and the rib precursor layer is transferred onto the substrate supporting the electrode precursor layer, or after the rib precursor is applied to the forming mold equipped with the printing mask of the rib precursor, the rib precursor is transferred in a state of a film onto the substrate supporting the electrode precursor layer, thus the rib precursor layer can be advantageously formed.

For forming the rib precursor layer, a paste-like rib precursor suitable to thick film formation is normally used. Preferably, the rib precursor paste is composed of a photo-curable material, but if necessary, a heat-curable material or a material that can be cured under other conditions can constitute the rib precursor. For example, a rib precursor paste may be composed of a paste in which ceramic powder and other essential ingredients are uniformly scattered in a photo-curable resin.

The transfer of a rib precursor layer by use of a forming mold can be advantageously carried out particularly by use of a flexible forming mold. A flexible forming mold used herein may have various forms, but a preferable one is a forming mold having a supporting body and a shaping layer supported by the supporting body and equipped on the surface with a groove pattern having a shape and dimensions corresponding to those of the protruding pattern of the ribs. Preferably, the transfer of a rib precursor layer by use of such a flexible forming mold can be advantageously carried out by the following steps of: filling the groove pattern of a flexible forming mold preferably with a paste-like photo-curable rib precursor; transferring the rib precursor onto the surface of a substrate having the electrode precursor layer formed in the previous step; and forming a rib precursor layer having a predetermined pattern by irradiating the rib precursor with light that can initiate curing of the rib precursor.

The transfer of a rib precursor layer by use of such a flexible forming mold can be advantageously carried out particularly by the following method.

First, a flexible forming mold is prepared, which is duplicated from a die having a shape and dimensions in accordance with a rib such as a PDP rib. Normally, a flexible forming mold has a two-layer structure consisting of a supporting body and a shaping layer supported by the supporting body, but if the shaping layer can function as a supporting body, the use of the supporting body may be omitted. Basically, a flexible forming mold has a two-layer structure, but it is possible to additionally provide a layer or coating, if necessary.

The flexible forming mold used in the process of the present invention is not restricted in the form, material, thickness, and so forth, as long as the supporting body can support the shaping layer and have sufficient flexibility and proper hardness to ensure the flexibility of the forming mold. Generally, a flexible film made of a plastic material (plastic film) can be advantageously used as a supporting body. Preferably, the plastic film is transparent and at least it is necessary to have transparency enough to transmit ultraviolet rays used for irradiation to form a shaping layer. Moreover, if the formation of PDP ribs or other ribs from a photo-curable rib precursor by use of this forming mold is particularly taken into consideration, it is preferable for both the supporting body and the shaping layer to be transparent.

In order to control the pitch precision of the grooves of the flexible forming mold so as to be within tens of ppm in the plastic film to be used as a supporting body, it is preferable to select a plastic material for a plastic film, which is by far harder than the forming material (preferably, a photo-curable material such as an ultraviolet curable composition) constituting the shaping layer involved in groove formation. Generally, the coefficient of curing contraction of a photo-curable material is approximately several percent, therefore, it is impossible to control the pitch precision of grooves so as to be within tens of ppm when a soft plastic film is used as a supporting body because the dimensions of the supporting body itself change owing to the curing contraction. On the other hand, when the plastic film is hard, it is possible to maintain a high pitch precision of grooves because the dimensional precision of the supporting body itself is maintained even if the photo-curable material cures and contracts. Moreover, when the plastic film is hard, there is an advantage in both the formability and the dimensional precision because the variations in pitch when ribs are formed can be suppressed so as to be small. Still moreover, when the plastic film is hard, because the pitch precision of grooves of the forming mold depends only on the change in the dimensions of the plastic film, therefore, in order to stably and constantly provide a forming mold having a desired pitch precision, all that is required as a post process is only to examine that the plastic film is manufactured with the scheduled dimensions in the forming mold and remains unchanged at all.

An example of a plastic material suitable to plastic film formation includes, but is not limited to, polyethylene terephthalate (PET), polyethylene naphthalate (PEN), extended polypropylene, polycarbonate, triacetate, and so forth. A PET film is particularly useful as a supporting body, and a polyester film, for example, a Tetron™ film can be advantageously used as a supporting body. These plastic films can be used as a single film or a multiple or laminated film consisting of two or more combined films.

The plastic films and other supporting bodies described above may be used in various thicknesses in accordance with the structure, etc., of the forming mold, but a range of approximately 50 to 500 μm is normal, and a range of approximately 100 to 400 μm is preferable. If the thickness of the supporting body falls below 50 μm, the rigidity of a film becomes too low and wrinkles or bends are likely to occur. On the contrary, if the thickness of the supporting body exceeds 500 μm, the flexibility of a film is lowered and the handling performance is deteriorated.

A flexible forming mold has a shaping layer on the supporting body described above. A shaping layer may have various compositions and thicknesses. For example, a shaping layer may be composed of a cured resin of an ultraviolet curable composition including acrylic monomer and/or oligomer as a main component. The method for forming a shaping layer from such an ultraviolet curable composition is useful because a huge heating oven is not required for forming a shaping layer and it is possible to obtain a cured resin in a relatively short time by curing.

An acrylic monomer suitable to formation of a shaping layer includes, but is not limited to, urethane acrylate, polyether acrylate, polyester acrylate, acrylic amide, acrylonitrile, acrylic acid, acrylic acid ester, and so forth. An acrylic oligomer suitable to formation of a shaping layer includes, but is not limited to, urethane acrylate oligomer, polyester acrylate oligomer, polyester acrylate oligomer, epoxy acrylate oligomer, and so forth. Particularly, urethane acrylate or its oligomer can provide a flexible and rigid cured resin layer after curing, and the curing speed is by far higher compared to other acrylate substances, therefore, the productivity of the forming mold can be improved. Moreover, if acrylic monomer or oligomer is used, the shaping layer becomes optically transparent. Therefore, a flexible forming mold equipped with such a shaping layer has an advantage that it can use a photo-curable forming material when forming PDP ribs or other ribs.

An ultraviolet curable composition may optionally contain a photopolymerization initiator (photo-curing initiator) or other additives, if necessary. For example, a photopolymerization initiator includes 2-hydroxy-2-methyl-1 -phenylpropane-1-on, bis(2,4,6-trimethylbenzoyl)phenylphosphineoxide, and so forth. Although the amount of the photopolymerization initiator to be used in an ultraviolet curable composition may be varied, normally it is preferable to use the amount of approximately 0.1 to 10 weight % on the basis of the total amount of the acrylic monomer and/or oligomer. When the amount of the photopolymerization initiator falls below 0.1 weight %, a problem is caused that the curing reaction speed is considerably reduced or curing is not sufficient. On the contrary, when the amount of the photopolymerization initiator exceeds 10 weight %, a problem is caused that a state, in which the photopolymerization initiator that has not reacted yet remains after the curing process is completed, is established and therefore, the resin is yellowed or deteriorated, or the resin contracts owing to volatilization. Other useful additives include, for example, an anti-static additive.

The shaping layer may be used in various thicknesses in accordance with the structure of the forming mold and ribs on the substrate, and so forth, but a range of approximately 5 to 1,000 μm is normal, a range of approximately 10 to 800 μm is preferable and a range of approximately 50 to 700 μm is most preferable. When the thickness of the shaping layer falls below 5 μm, a problem is caused that a necessary height of the rib cannot be obtained.

After the flexible forming mold having the structure described above is prepared, the groove pattern in the shaping layer is filled with, preferably, a paste-like rib precursor and transferred onto the surface of the substrate provided with the electrode precursor layer. This process can be advantageously carried out by, for example, supplying the rib precursor in a predetermined amount necessary for forming ribs on a substrate such as a glass substrate, filling the groove pattern in the shaping layer with the rib precursor in such a way that the forming mold and the substrate sandwich the rib precursor, and transferring the rib precursor layer onto the substrate by curing the rib precursor. The rib precursor can be advantageously cured by the irradiation of light (e.g., ultraviolet rays) that can initiate curing of the rib precursor, for example, when the rib precursor is photo-curable. In this manner, a substrate equipped with the rib precursor layer having a predetermined pattern as well as the electrode precursor layer can be obtained.

Here, the “rib precursor” means any forming material that can be formed into a rib, which is the final object, and is not limited as long as it can be formed into a rib-formed body. The rib precursor may be heat-curable or photo-curable. Particularly, the photo-curable rib precursor can be much effectively used in combination with the transparent flexible forming mold described above. The flexible forming mold is almost free from bubbles and defects such as deformation, as described above, and capable of suppressing nonuniform scattering of light, etc. Thus, the rib-forming material is cured uniformly and the ribs of uniform and excellent quality can be obtained.

One example of the composition suitable to a rib precursor includes one basically containing (1) a ceramic component such as aluminum oxide that provides the. configuration of the rib, (2) a glass component such as lead glass and phosphate glass that provides the rib with density by filling the gaps between the ceramic components therewith, and (3) a binder component containing, holding, and binding the ceramic component to each other, and its curing agent or polymerization initiator. It is preferable that the binder component is cured by irradiation of light, not by heating. In this case, it is no longer necessary to take the thermal deformation of the glass substrate into consideration. Moreover, if necessary, an oxidation catalyst consisting of an oxide, salt 5 and complex of chromium (Cr), manganese (Mn), iron (Fe), cobalt (Co), nickel (Ni), copper (Cu), zinc (Zn), indium (In) or tin (Sn), ruthenium (Ru), rhodium (Rh), palladium (Pd), silver (Ag), iridium (Ir), platinum (Pt), gold (Au) or cerium (Ce) can be added to the composition to lower the temperature at which the binder component is removed.

After the electrode precursor layer and the rib precursor layer are sequentially formed on the substrate, as described above, the electrode precursor layer and the rib precursor layer are simultaneously sintered. When a forming mold such as a flexible forming mold is used, sintering is carried out after the substrate is removed from the forming mold. The sintering process can be carried out by use of a sintering oven generally used in manufacturing a PDP substrate, etc. The process of simultaneously sintering the electrode precursor layer and the rib precursor layer can be carried out under variable conditions depending on the composition of those layers or other factors. As for the sintering temperature, a range of approximately 400 to 600° C. is normal, and a range of approximately 450 to 560° C. is preferable. As for the sintering time, a range of approximately 10 to 120 minutes is normal, and a range of approximately 30 to 60 minutes is preferable.

The manufacturing process of a panel substrate according to the present invention can be advantageously carried out, as described above. For further understanding of the present invention, a preferred embodiment of the present invention is described below referring to the accompanied drawings.

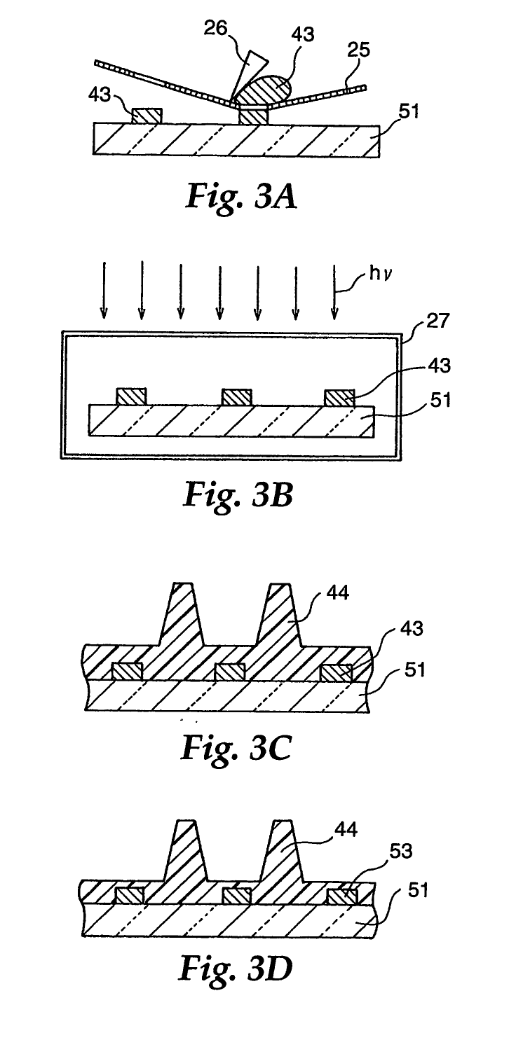

FIG. 3 is sectional views illustrating the manufacturing process of a substrate for a PDP according to the present in order. As shown in FIG. 3 (A), a stripe-shaped electrode precursor layer 43 is printed in advance in a predetermined pattern on the surface of the glass substrate 51. In this example, the screen printing method is used, therefore, the photo-curable silver paste 43 as an electrode precursor is extruded onto the glass substrate 51 through the opening of a screen printing mask 25. To improve the efficiency in extrusion, a squeezer 26 is used.

Next, in order to cure the silver paste after printed, the glass substrate 51 is put into a curing oven 27 and irradiated with light such as ultraviolet rays (hν) under a nitrogen gas atmosphere, as shown in FIG. 3 (B). The silver paste is cured and the electrode precursor layer 43 is thus formed.

After the electrode precursor layer is formed as described above, a rib precursor layer 44 is formed on the glass substrate 51 as shown in FIG. 3 (C). First, the glass substrate is taken out from the curing oven, and after a forming mold on which a desired rib pattern has been formed is aligned in advance so that the rib pattern is formed between the electrode patterns, a paste-like photo-curable rib precursor is coated on the glass substrate and the forming mold is laminated thereon. Then, the paste-like rib precursor is cured by the irradiation of light (for example, ultraviolet rays) that can cause the rib precursor to react. After the rib precursor is cured, the used forming mold is removed.

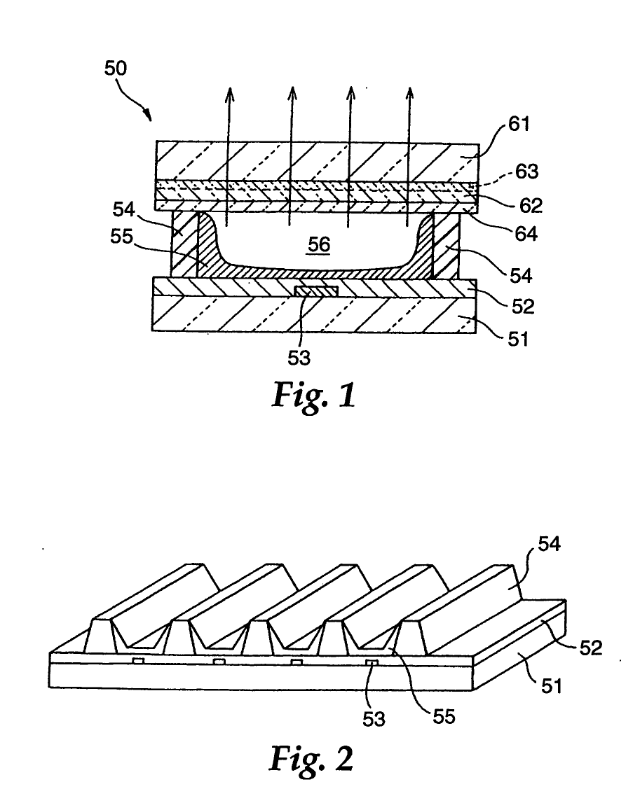

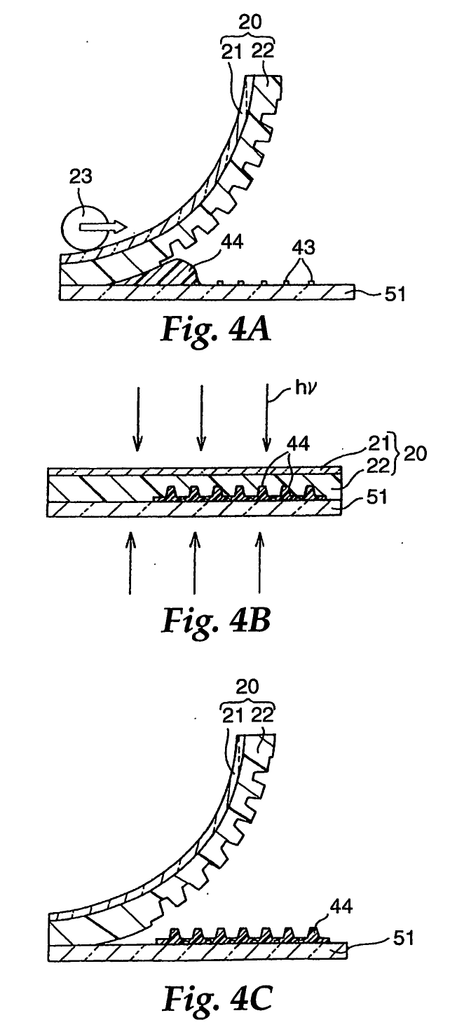

The forming process of the rib precursor layer shown in FIG. 3 (C) can be preferably carried out by use of the method that is illustrated in order in FIG. 4. Note that, the present process can be advantageously carried out by use of the manufacturing equipment shown in FIGS. 1 to 3 of JP 2001-191345.

First, a glass substrate equipped with a stripe-shaped electrode precursor layer is prepared and set on a base of the production apparatus. Then, as shown in FIG. 4 (A), a flexible forming mold 20 consisting of a supporting body 21 that supports a shaping layer 22 having a groove pattern on its surface is placed at a predetermined position on the glass substrate 51, and the glass substrate 51 and the forming mold 20 is aligned. As shown, the electrode precursor layer 43 has already been formed on the surface of the glass substrate 51. As the forming mold 20 is transparent, it is possible to easily align itself with the electrode on the glass substrate 51. To be precise, it is possible to carry out the alignment visually or by use of a sensor such as a CCD camera. At this time, if necessary, it is possible to make the groove of the forming mold 20 coincide with the distance between two neighboring electrodes on the glass substrate by adjusting temperature and humidity. This is because the forming mold 20 and the glass substrate 51 extend or contract according to the change in temperature and humidity but differ in the magnitude in extension or contraction. Therefore, after the alignment between the glass substrate 51 and the forming mold 20 is completed, it is necessary to control the temperature and humidity so that they are maintained unchanged. This controlling method is particularly effective in manufacturing a substrate for a large PDP.

Subsequently, a laminate roll 23 is mounted on one end of the forming mold 20. Preferably, the laminate roll 23 is a rubber roll. At this time, it is preferable that one end of the forming mold 20 is fixed onto the glass substrate 51. This is because the glass substrate 51 and the forming mold 20 that have already been aligned are prevented from deviating from each other.

Next, the other end of the forming mold 20 is lifted up over the laminate roll 23 by use of a holder (not shown) so that the glass substrate 51 is laid bare. At this time, be careful not to exert tension on the forming mold 20. This is because to prevent wrinkles from occurring in the forming mold 20 and maintain the alignment between the forming mold 20 and the glass substrate 51. However, as long as the alignment is maintained, other means can be used. In the present method, even if the forming mold 20 is lifted up as shown schematically, the exact alignment can be resumed in the following laminating process, because the forming mold 20 has elasticity.

Thereafter, a predetermined amount of the rib precursor 44 necessary for forming ribs is supplied onto the glass substrate 51. A nozzle-attached paste hopper, for example, can be used for supply of the rib precursor. The details of the rib precursor have been described above.

Next, a rotary motor (not shown) is driven to move the laminate roll 23 on the forming mold 20 at a predetermined speed in the direction of the arrow in FIG. 4 (A). As the laminate roll 23 moves on the forming mold 20 in this manner, a pressure due to the self-weight of the laminate roll 23 is sequentially applied to the forming mold 20 from the one end to the other, thus the rib precursor 44 spreads between the glass substrate 51 and the forming mold 20 and the grooves of the forming mold 20 are also filled therewith. At this time, the thickness of the rib precursor can be adjusted in a range between several μm to tens of μm by properly controlling the viscosity of the rib precursor or the diameter, weight or traveling speed of the laminate roller.

According to the illustrated method, even if the groove of the forming mold captures air therein as an air channel, the captured air can be efficiently excluded to the outside or the ambient area of the forming mold when the above-mentioned pressure is exerted. As a result, the present method is capable of preventing bubbles from remaining even if the filling of the rib precursor is carried out under the atmospheric pressure. In other words, depressurization is not required for the filling of the rib precursor. Of course, it is possible to more easily remove the bubbles by means of depressurization.

Subsequently, the rib precursor is cured. When the rib precursor 44 spread on the glass substrate 51 is photo-curable, the laminated body of the glass substrate 51 and the forming mold 20 is put in a light irradiation apparatus (not shown) and the rib precursor 44 is irradiated with light such as ultraviolet rays for curing via the glass substrate 51 and the forming mold 20. Thus, the rib precursor layer 44 as shown in FIG. 4 (C) can be obtained.

After the electrode precursor layer and the rib precursor layer are sequentially formed, as described above, in a state in which these layers are bonded to the glass substrate, the glass substrate and the forming mold are taken out from the light irradiation apparatus and the forming mold 20 is peeled off and removed as shown in FIG. 4 (C). Because the forming mold 20 used here is excellent also in handling, it is possible to easily peel off and remove the forming mold 20 with a small force without destroying the rib precursor layer 44 bonded to the glass substrate 51. Of course, huge equipment is not required for this peeling and removing work.

Next, the glass substrate on which the electrode precursor layer and the rib precursor layer have been formed is put in a sintering oven and the two layers are sintered simultaneously according to the predetermined sintering schedule. Although the sintering temperature can be changed in a wide range, as described above, a range of approximately 400 to 600° C. is normal. When the glass substrate is taken out from the sintering oven, the glass substrate 51, equipped with the electrodes 53 and the ribs 54 each formed with more or less contraction, is obtained, as shown in FIG. 3 (D). The formed product thus obtained exactly coincides with the objective substrate for a PDP both in the shape and in the dimensions and is free from defects such as a deficiency of barrier rib.

Now, the present invention is described with reference to examples thereof. Note that these examples do not restrict the present invention.

### EXAMPLE 1

Preparation of a Silver Paste for Electrode Formation:

The following components were mixed carefully to prepare a photo-curable silver paste, in which each component was uniformly dispersed:

| | |
|---|---|
| Silver powder (manufactured by Tanaka Kikinzoku Kogyo K.K.) | 65.7 g |
| Low-melting point lead glass powder | 2.7 g |
| (manufactured by Asahi Glass Co.) | |
| Photo-curable oligomer: bisphenol A diglycidyl methacrylate | 7.5 g |
| acid adduct (manufactured by Kyoeisha Chemical Co., Ltd.) | |
| Photo-curable monomer: triethylene glycol dimethacrylate | 3.0 g |
| (manufactured by Wako Pure Chemical Industries, Ltd.) | |
| Diluent: 1,3-butanediol (manufactured by Wako Pure | 10.5 g |
| Chemical Industries, Ltd.) | |
| Photo-curing initiator: 2-benzoyl 2-dimethoxyamino-1- | 0.6 g |
| (4-morpholinophenyl) butanone-1 (manufactured by Ciba-Gigy) | |

Preparation of a Ceramic Paste for Rib Formation:

The following components were mixed carefully
to prepare a photo-curable ceramic paste, in which
each component was uniformly dispersed:

| | |
|---|---|
| Photo-curable oligomer: bisphenol A diglycidyl methacrylate | 21.0 g |
| acid adduct (manufactured by Kyoeisha Chemical Co., Ltd.) | |
| Photo-curable monomer: triethylene glycol dimethacrylate | 9.0 g |
| (manufactured by Wako Pure Chemical Industries, Ltd.) | |
| Diluent: 1,3-butanediol (manufactured by Wako Pure | 30.0 g |
| Chemical Industries, Ltd.) | |
| Photo-curing initiator: bis (2,4,6-trimethylbenzoyl)- | 0.3 g |
| phenylphosphineoxide) (manufactured by Ciba Specialty | |
| Chemicals K.K., the product name “IRGACURE819”) | |
| Surface active agent: phosphate propoxyalkyl polyol | 3.0 g |
| Inorganic particles: a mixture of lead glass and ceramic | 180.0 g |
| particles (manufactured by Asahi Glass Co.) | |

Manufacture of a Back Plate for PDP:

A glass substrate made of soda-lime glass having a thickness of 2.8 mm was prepared and the photo-curable silver paste prepared as described above was coated on the surface of the glass substrate by use of the screen printing method. The screen printing mask used in this example had an opening for electrode pattern formation having a width of 120 μm and a pitch of 300 μm.

Next, the glass substrate on which the silver paste had been coated was put in a closed vessel having a quartz glass window, and the inside of the vessel is filled with nitrogen gas and purged of oxygen until the oxygen concentration fell below 0.1%. The coating film of silver paste was irradiated for 20 seconds with ultraviolet rays having a wavelength of 300 to 400 nm (D-bulb made by FUSION UV Systems, Inc.) through the quartz glass window and thus the silver paste was cured. Then, the glass substrate equipped with the silver electrode precursor layer was taken out from the closed vessel.

In order to form ribs by use of the transfer method, a flexible forming mold designed to form a rib precursor having a rib pitch of 300 μm, a rib height of 200 μm and a rib top width of 80 μm was prepared. The forming mold was arranged through the positional alignment on the glass substrate equipped with the silver electrode precursor layer so that the groove pattern of the forming mold was opposed to the glass substrate. Then, the gap between the forming mold and the glass substrate was filled with the photo-curable ceramic paste prepared as described above.

After the filling of the ceramic paste was completed, the forming mold was laminated in such a way that the surface of the glass substrate was covered therewith. The grooves of the forming mold were completely filled with the ceramic paste by carefully pressing the forming mold by use of the laminate roll.

In this state, both the surfaces of the forming mold and the glass substrate were irradiated for 30 seconds with ultraviolet rays having a wavelength of 400 to 450 nm (peak wavelength: 352 nm) by use of a fluorescent lamp manufactured by Philips Co. The quantity of irradiation of ultraviolet rays was 200 to 300 mJ/cm². The ceramic paste cured and became a barrier rib precursor layer. Then, the glass substrate together with the rib precursor layer thereon was peeled from the forming mold.

The glass substrate equipped with the silver electrode precursor layer and the rib precursor layer was put in the sintering oven and sintered at a temperature of 550° C. for one hour. After the sintered glass substrate was taken out from the sintering oven, the objective back plate for a PDP with silver electrodes and ribs was obtained. It was confirmed that the silver electrodes and ribs were formed simultaneously without any damages to the back plate. The electrical resistivity of the silver electrode was 1 ohm per 1 cm, for both the portion formed on the rib and the portion not formed on the rib, respectively, and from this fact it was confirmed that the silver electrode was conductive. Moreover, it was confirmed that the electrical resistivity between neighboring silver electrodes was infinity and that the silver electrodes were formed properly.

### EXAMPLE 2

A back plate for a PDP was manufactured by repeating the processes described in Example 1. In this example, however, the same amount (0.6 g) of bis(2,4,6-trimethylbenzoyl)-phenylphosphineoxide) (manufactured by Ciba Specialty Chemicals K.K., the product name “IRGACURE819) was used instead of 2-benzoyl-2-dimethoxyamino 1-(4-morpholinophenyl)butanone-1 as a photo-curing initiator in preparing the photo-curable silver paste. Moreover, for curing, the silver paste was irradiated for 20 seconds with ultraviolet rays having a wavelength of 400 to 500 nm (D-bulb made by FUSION UV Systems, Inc.) through the quartz glass window.

The glass substrate equipped with the silver electrode precursor layer and the rib precursor layer was put in a sintering oven and sintered for one hour at a temperature of 550° C. The sintered glass substrate was taken out from the sintering oven, and the objective back plate for a PDP with silver electrodes and ribs was obtained. It was confirmed that the silver electrodes and ribs were formed simultaneously without any damages to the back plate. The electrical resistivity of the silver electrode was 1 ohm per 1 cm, for both the portion formed on the rib and the portion not formed on the rib, respectively, and from this fact it was confirmed that the silver electrode was conductive. Moreover, it was confirmed that the electrical resistivity between neighboring silver electrodes was infinity and that the silver electrodes were formed properly.

### COMPARISON EXAMPLE 1

A back plate for a PDP was manufactured by repeating the processes described in Example 1. In this example, however, for comparison, the back plate for a PDP was manufactured according to the following procedure by use of the photo-curable silver paste and the photo-curable ceramic paste prepared in Example 1.

A glass substrate made of soda-lime glass having a thickness of 2.8 mm was prepared and the photo-curable silver paste was coated on the surface of the glass substrate by use of the screen printing method. The screen printing mask used in this example had an opening for electrode pattern formation having a width of 120 μm and a pitch of 300 μm.

Next, the glass substrate on which the silver paste had been coated was put in a closed vessel having a quartz glass window. Under an ambient atmosphere, the coating film of silver paste was irradiated for 20 seconds with ultraviolet rays having a wavelength of 300 to 400 nm (D-bulb made by FUSION UV Systems, Inc.) through the quartz glass window and thus the silver paste was cured. The glass substrate equipped with the silver electrode precursor layer in which the silver paste had not cured well was taken out from the closed vessel.

In order to form ribs by use of the transfer method, a flexible forming mold designed to form a rib precursor having a rib pitch of 300 μm, a rib height of 200 μm and a rib top width of 80 μm was prepared. The forming mold was arranged through the positional alignment on the glass substrate equipped with the silver electrode precursor layer so that the groove pattern of the forming mold was opposed to the glass substrate. Then, the gap between the forming mold and the glass substrate was filled with the photo-curable ceramic paste.

After the filling of the ceramic paste was completed, the forming mold was laminated in such a way that the surface of the glass substrate was covered therewith. The grooves of the forming mold were completed filled with the ceramic paste by carefully pressing the forming mold by use of the laminate roll. At this moment, however, the silver paste that had not cured well was mixed with the ceramic paste and the electrode pattern was destroyed. After the destruction of the electrode pattern was recognized, further photo-curing process for curing the ceramic paste was omitted. As a result, it was impossible to obtain a back plate for a PDP equipped with silver electrodes and ribs in this example.

1. A method of making a substrate for an image display panel comprising:
forming an electrode precursor comprising a photo-curable material on a surface of a substrate in a pattern;
forming a rib precursor layer on the surface of the substrate on which the electrode precursor layer has been formed; and
simultaneously sintering the electrode precursor layer and the rib precursor layer, wherein the precursor layer is irradiated with light under an inert gas atmosphere.

2. The method of claim 1, wherein the substrate is a glass substrate.

3. The method of claim 1, wherein the electrode precursor layer is formed by a method selected from screen printing method and photolithography.

4-5. (canceled)

6. The method of claim 1, wherein the inert gas is a nitrogen gas.

7. The method of claim 1, wherein the rib precursor layer is formed by a transfer method.

8. The method of claim 7, wherein the transfer method utilizes a flexible forming mold.

9. The method of claim 8, wherein the flexible forming mold comprises a supporting body and a shaping layer supported by the supporting body, said shaping layer comprising a groove pattern having a shape and dimensions corresponding to those of the protrusion pattern of the ribs.

10. The method of claim 9, wherein the rib precursor layer having the predetermined pattern is formed by filling the groove pattern of the flexible forming mold with a photo-curable rib precursor, transferring the rib precursor onto the surface of the substrate provided with the electrode precursor layer, and curing the rib precursor by the irradiation with light capable of initiating curing.

11. The method of claim 10, wherein said method further comprises a step of separating the substrate, on which the electrode precursor layer and the rib precursor layer have been formed, from the flexible forming mold.

12. The method of claim 1, wherein the electrode precursor layer and the rib precursor layer are simultaneously sintered at a temperature of 400 to 600° C. for 10 to 120 minutes.

13. The method of claim 1, wherein the image display panel is a plasma display panel.

14. The method of claim 13, wherein the electrode is an address electrode and a pair of address electrodes are provided independently on the surface of the substrate substantially in parallel to each other.

15. The method of claim 13, wherein the ribs have a straight rib pattern wherein a plurality of ribs are arranged parallel to each other.

16. The method of claim 13, wherein the ribs have a grid-shaped rib pattern.

17. A method of making a substrate for an image display panel comprising:
forming an electrode precursor on a surface of a substrate in a pattern;
forming a rib precursor layer by a transfer method on the surface of the substrate on which the electrode precursor layer has been formed; and
simultaneously sintering the electrode precursor layer and the rib precursor layer.
